(19) United States
(12) Patent Application Publication
(10) Pub. No.: US 2014/0296182 A1
(43) Pub. Date: Oct. 2, 2014

(54) METHOD AND COMPOSITION FOR TREATING LICE INFESTATION

(71) Applicants: Orna Levin, Kfar Netter (IL); Yochanan Forman, Kibbutz Maabarot (IL); Michael Royz, Rehovot (IL)

(72) Inventors: Orna Levin, Kfar Netter (IL); Yochanan Forman, Kibbutz Maabarot (IL); Michael Royz, Rehovot (IL)

(21) Appl. No.: 14/241,045

(22) PCT Filed: Aug. 28, 2012
(86) PCT No.: PCT/IB2012/054416

§ 371 Date: Mar. 27, 2014

Related U.S. Application Data
(60) Provisional application No. 61/528,318, filed on Aug. 29, 2011.

(51) Int. Cl. A01N 55/00; A01N 37/02

(52) U.S. Cl. CPC A01N 55/00; A01N 37/02
USPC 514/63

(57) ABSTRACT

Methods and compositions for the treatment of pediculosis comprising: between 1 and 20% (w/w) isopropyl myristate; between 1 and 20% (w/w) silicone oil; and at least 20% (w/w) water. Methods and compositions for dissolving nit glue comprising at least three components selected from the group consisting of benzyl alcohol, diacetone alcohol, acetic acid, and triethyl citrate

### RELATED APPLICATION

The present application gains priority from U.S. Provisional Patent Application No. 61/528,318 filed 29 Aug. 2011, which is included by reference as if fully set-forth herein.

### FIELD AND BACKGROUND OF THE INVENTION

The invention, in some embodiments, relates to the field of pest control, and more specifically, but not exclusively, to methods and compositions for treating infestations by insects, especially infestations by lice (pediculosis).

Lice belong to the group of external parasites living on warm-blooded animals. An infestation of lice is called pediculosis. In humans there are three different varieties of pediculosis caused by different types of lice: (1) Pediculosis pubis in the pubic area, caused by Pithirus pubis; (2) Pediculosis corporis on the trunk, caused by Pediculus humanus humanus; and (3) Pediculosis capitis on the head, caused by Pediculus humanis capitis. Pediculosis affects millions of humans world-wide, causing itching and discomfort.

Generally, infestation is treated by application of a fluid composition that kills the lice by poisoning (e.g., compositions including pesticides), or by physical means (smothering, dehydration).

One type of non-toxic composition for treating lice infestation includes a combination of silicone oil and isopropyl myristate, for example commercially available as Resultz® (50% isopropyl myristate and 50% cyclomethicone) or Full Marks Solution (SSL Healthcare Ireland Ltd, Dublin, Ireland). Such compositions kill adult lice through two modes of action. The isopropyl myristate is a pediculicide which dissolves the waxy coating of the louse exoskeleton, leading to dehydration of the louse, while the silicone oil, which is a glidant, makes it difficult for weakened lice to grasp the hair, such that the lice are easy to comb out from the hair. Additionally, silicone oil has some lice choking effect. For use, the composition is carefully applied to the scalp and the entire length of the hair shafts, maintained in contact therewith for at least 10 minutes followed by washing, rinsing and combing with a fine-tooth comb to remove dead lice.

A disadvantage of such compositions is that these lack efficacy against nits, the eggs of lice that are attached to the hair with a waterproof adhesive. Additionally, subsequent to use, some such compositions leave an unpleasant residue that is not easily washed out.

It is desirable to have a composition for the treatment of lice that has some advantage over known treatments.

### SUMMARY OF THE INVENTION

Some embodiments of the invention relate to methods and compositions for the treatment of infestations by insects, especially infestations by lice and nits (pediculosis).

Aspects and embodiments of the invention are described in the specification hereinbelow and in the appended claims.

According to some embodiments, there is provided a composition useful for the treatment of pediculosis, such as infestation by pediculus humanus capitus, the composition comprising between 1 and 20% (w/w) isopropyl myristate; between 1 and 20% (w/w) silicone oil; and at least 20% (w/w) water.

According to some embodiments there is provided a composition comprising between 1 and 20% (w/w) isopropyl myristate; between 1 and 20% (w/w) silicone oil; and at least 20% (w/w) water, for use in treating pediculosis, such as an infestation by pediculus humanus capitus

According to some embodiments, there is provided the use of a composition comprising between 1 and 20% (w/w) isopropyl myristate; between 1 and 20% (w/w) silicone oil; and at least 20% (w/w) water, for the manufacture of a medicament for treating of pediculosis, such as an infestation by pediculus humanus capitus.

According to some embodiments, there is provided a method for the treatment of pediculosis, such as an infestation by pediculus humanus capitus, comprising topically administering to a subject in need thereof a composition comprising between 1 and 20% (w/w) isopropyl myristate, between 1 and 20% (w/w) silicone oil, and at least 20% (w/w) water.

According to some embodiments, the method further comprises combing the hair of the subject. According to some embodiments, a period of time is allowed to elapse between application of the composition and combing of the hair, such as, for example, from about 5 to about 15 minutes.

According to some embodiments, there is provided a method for the preparation of a composition useful in the treatment of pediculosis, such as an infestation by pediculus humanus capitus, comprising mixing together between 1 and 20% (w/w) isopropyl myristate, between 1 and 20% (w/w) silicone oil, and at least 20% (w/w) water. According to some embodiments, the composition is a homogenous fluid.

According to some embodiments, silicone oil is selected from the group consisting of a polyalkyl siloxane (such as cyclomethicone and/or dimethicone), a polyaryl siloxane, a polyalkylaryl siloxane, a polyether siloxane copolymer, and combinations thereof.

According to some embodiments, the composition further comprises at least one of a hair conditioner and a lubricant, such as, for example, a vegetable oil, a fatty alcohol, panthenol, polyquaternium, cyclopentasiloxane, dimethiconol, a copolymer of Cetyl Dimethicone and an alkoxylated derivative of Dimethicone containing ethylene oxide and propylene oxide (e.g., Cetyl PEG/PPG-10/1 Dimethicone), or combinations thereof

According to some embodiments, the composition further comprises at least one of a thickener and a stabilizer, such as, an anionic acrylic polymer (for example, polyacrylate crosspolymer).

According to some embodiments, the composition further comprises at least one water in oil emulsifier and/or at least one oil in water emulsifier.

According to some embodiments, the composition further comprises at least one non-aqueous solvent, such as, for example, isopropanol.

According to some embodiments, the composition has a pH of less than about 4.

According to some embodiments, the composition further comprises a pH adjuster, such as, for example, at least one of acetic acid and triethanolamine, and mixtures thereof

According to some embodiments, the composition further comprises at least one solvent effective in dissolving nit glue, such as, for example, at least three components selected from the group consisting of benzyl alcohol, diacetone alcohol, acetic acid, and triethyl citrate.

According to some embodiments, there is provided a composition for dissolving nit glue comprising at least three components selected from the group consisting of benzyl alcohol, diacetone alcohol, acetic acid, and triethyl citrate.

According to some embodiments, there is provided a composition comprising at least three components selected from the group consisting of benzyl alcohol, diacetone alcohol, acetic acid, and triethyl citrate, for use in treating pediculosis.

According to some embodiments, there is provided use of a composition comprising at least three components selected from the group consisting of benzyl alcohol, diacetone alcohol, acetic acid, and triethyl citrate, in the manufacture of a medicament for the treatment of pediculosis.

According to some embodiments, there is provided a method for the treatment of pediculosis, comprising topically administering to a subject in need thereof a composition comprising at least three components selected from the group consisting of benzyl alcohol, diacetone alcohol, acetic acid, and triethyl citrate.

According to some embodiments, there is provided a method for the preparation of a composition useful in the treatment of pediculosis comprising mixing together at least three components selected from the group consisting of benzyl alcohol, diacetone alcohol, acetic acid, and triethyl citrate.

According to some embodiments, the composition further comprises a hair wetter, such as a hair wetter having a spreading coefficient of at least about 1100 mm/10 minutes, (for example, at least one of isopropyl myristate, dicaprylyl ether, dicaprylyl carbonate, isopropyl palmitate, C12-15 alkyl benzoate, isopropyl isostearate, butyl stearate, diisopropyl adipate, diisobutyl adipate, diethylhexyl adipate, butyl myristate, hexyl myristate, tributyl citrate, acetyltributyl citrate, acetyltriethyl citrate, ethylhexyl cocoate, ethylhexyl stearate, ethylhexyl pelargonate, ethylhexyl succinate, ethylhexyl cocoate, ethyl oleate, propylene glycol dicaprylate/caprate, propylheptyl caprylate, coco-caprylate, and PPG-2 myristyl ether propionate, or combinations thereof). According to some embodiments, the hair wetter comprises isopropyl myristate.

According to some embodiments, the composition further comprises a pharmaceutically acceptable carrier.

As used herein, the term “pharmaceutically acceptable” means approved by a regulatory agency of the US Federal or a US state government or listed in the U.S. Pharmacopeia or other generally recognized pharmacopeia for use in animals, and more particularly in humans. Herein, the phrase “pharmaceutically acceptable carrier” refers to an approved carrier or a diluent that does not cause significant irritation to an organism and does not abrogate the biological activity and properties of the administered conjugate.

As used herein, the term “carrier” refers to a diluent, adjuvant, excipient, or vehicle with which the therapeutic is administered.

Unless otherwise defined, all technical and scientific terms used herein have the same meaning as commonly understood by one of ordinary skill in the art to which the invention pertains. In case of conflict, the specification, including definitions, takes precedence.

As used herein, the term “treating” includes curing a condition, treating a condition, preventing a condition, treating symptoms of a condition, curing symptoms of a condition, ameliorating symptoms of a condition, treating effects of a condition, ameliorating effects of a condition, and preventing results of a condition.

Herein the term “excipient” refers to an inert substance added to a pharmaceutical composition to further facilitate processes and administration of the active pharmaceutical ingredients.

As used herein, the terms “comprising”, “including”, “having” and grammatical variants thereof are to be taken as specifying the stated features, integers, steps or components but do not preclude the addition of one or more additional features, integers, steps, components or groups thereof These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about” the term “about” is intended to indicate +/−10%.

### DESCRIPTION OF SOME EMBODIMENTS OF THE INVENTION

The invention, in some embodiments, relates to the field of pest control, and more specifically, but not exclusively, to methods and compositions for treating infestations by insects, especially infestations by lice (pediculosis).

The principles, uses and implementations of the teachings herein may be better understood with reference to the accompanying description. Upon perusal of the description present herein, one skilled in the art is able to implement the invention without undue effort or experimentation.

Before explaining at least one embodiment in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

The present invention, in at least some embodiments, provides a composition comprising a pediculicide component such as isopropyl myristate, and a glidant, such as silicone oil in a solvent that includes water.

In some embodiments the composition comprises at least about 20% water (w/w). In some embodiments, the composition comprises at least about 30%, at least about 35%, at least 40%, at least 50%, and even at least about 60% water (w/w). In some embodiments, the composition comprises from about 45 to about 70% water (w/w).

In some embodiments, the composition is a homogenous fluid.

In some embodiments, use of the composition to treat an infestation of the hair comprises spreading the composition on the hair; waiting a period of time to affect the lice (and in some embodiments, dissolve nit glue); combing the hair to remove (dead) lice and nymphs (and in some embodiments, detached nits); and optionally, rinsing the hair with water, in analogy to washing the hair after treatment with a hair conditioner or hair rinse-off mask.

The period of time waited is any suitable period of time, in some embodiments between 5 and 15 minutes, typically about 10 minutes.

Despite a relatively low concentration of pediculicide components, the composition is highly effective in killing adult and nymph lice. In some embodiments, the composition disclosed herein is effective against nits and hatched lice (nymphs and adults) when topically applied to a subject infested with lice, such that, all things being equal, hatching of nits and recurrence of the infestation is less likely to occur than with use of prior art compositions.

Such a composition allows a more generous amount of composition to be applied with less concern for application of too much composition.

Further, the water-including solvent provides a subjectively “cleaner” less-oily feel when the composition is applied to the hair.

Subsequent to use by application to the hair, the hair can be rinsed (with water) and most of the composition is washed out with little, if any, unpleasant or tacky residue.

In some embodiments, the composition comprises from about 1 to about 20% isopropyl myristate (w/w). In some embodiments, the composition comprises from about 1 to about 15%, from about 1 to about 10%, and even from about 5 to about 8% isopropyl myristate (w/w). In some embodiments, the composition comprises from about 5.5 to about 6% isopropyl myristate (w/w).

In some embodiments, the silicone oil is selected from the group consisting of a polyalkyl siloxane, a polyaryl siloxane, a polyalkylaryl siloxane or a polyether siloxane copolymer, and combinations thereof. In some embodiments, the polyalkyl siloxane comprises cyclomethicone. In some embodiments, the polyalkyl siloxane further comprises dimethicone.

In some embodiments, the composition comprises from about 1 to about 20% silicone oil (w/w). In some embodiments, the composition comprises from about 1 to about 15%, from about 1 to about 10%, and even from about 5 to about 10% silicone oil (w/w). In some embodiments, the composition comprises from about 7% (w/w). In some embodiments, the composition comprises not more than about 10% (w/w).

In addition to being effective pediculicides, isopropyl myristate and silicone oil also act as hair lubricants, easing combing of the hair to remove lice, nymphs and nits. In some embodiments, a composition includes additional hair lubricants, easing combing of the hair even further.

In some embodiments, a composition includes at least one hair conditioner. Such hair conditioners provide a pleasant feel to the hair after the hair is washed, but leave the hair very smooth, making it difficult for any surviving lice to subsequently attach to the hair.

In some embodiments, the hair conditioner comprises a moisturizer, a reconstructor (such as a hydrolyzed protein, including human hair keratin protein), a detangler, a thermal protector (such as a heat-absorbing polymer), a glosser (such as dimethicone), an oil (such as an essential fatty acid), a cationic surfactant (such as a pH-dependent amine, for example, ocentidine dihydrochloride; or a quaternary ammonium cation such as an alkyltrimethylammonium salt, cetylpyridinium chloride, polyethyoxylated tallow amine, benzalkonium chloride, benzethonium chloride, water-soluble cationic surfactant based on the amido-amine, dimethyldioctadecylammonium chloride, or dioctadecyldimethylammonium bromide, or mixtures thereof), a sequestrant (such as calcium disodium ethylene diamine tetra-acetate, glucono delta-lactone, sodium gluconate, potassium gluconate, sodium tripolyphosphate, or sodium hexametaphosphate, or mixtures thereof), an antistatic agent (such as a long-chain aliphatic amine, amide, or quaternary ammonium salt, including behentriomonium chloride or cocamidopropyl betaine; esters of phosphoric acid; polyethylene glycol esters; or polyols, or mixtures thereof), or combinations thereof

In some embodiments, the lubricant and/or conditioner is selected from the group consisting of vegetable oils, fatty alcohols, panthenol, polyquaternium, cyclopentasiloxane, dimethiconol, a copolymer of Cetyl Dimethicone and an alkoxylated derivative of Dimethicone containing ethylene oxide and propylene oxide (e.g., Cetyl PEG/PPG-10/1 Dimethicone), fatty amido-functional tertiary amines, an amine functionalized polydimethylsiloxane, an ethoxylated vegetal fatty amine, an amine functionalized polydimethylsiloxane copolymer, and an amine-functional silicone polymer, or combinations thereof

Some embodiments include thickeners and/or stabilizers, giving the composition the consistency of a lotion, a cream or gel, allowing application with less staining and composition flow into the eyes. In some embodiments, the thickener/stabilizer comprises an anionic acrylic polymer, in some embodiments selected from the group consisting of polyacrylate crosspolymer, methylene bisacrylamide, ethylene glycol diacrylate, polyethylene glycol dimethacrylate, diacrylamide, cyanomethacrylate, vinyloxyethacrylate, methacrylate, formaldehyde, glyoxal, compositions of the glycidylether type and epoxides, or combinations thereof In some embodiments, the thickener/stabilizer comprises at least one selected from the group consisting of Polyacrylate-1 Crosspolymer, PEG-150/Decyl Alcohol/SMDI Copolymer, PEG-150/Stearyl Alcohol/SMDI Copolymer, Acrylates/ Stearaeth-20 Methacrylate Copolymer, PVP, Sodium Acryloyldimethyl Taurate Copolymer, and Polyquaternium 37, or combinations thereof.

In some embodiments, a composition includes an emulsifier. In some such embodiments, emulsifiers assist in wetting the hair so that the composition more easily covers all the hairs evenly, even when only a moderate amount of composition is applied.

In some such embodiments, a composition includes an oil in water emulsifier. In some embodiments, a composition includes at least one oil in water emulsifier selected from the group consisting of Ceteareth-20, Ceteareth-12, PEG-75 Stearate, PEG-100 Stearate, PEG-40 Stearate, Polysorbate 80, Polysorbate-85, PEG-7 Glyceryl Cocoate, Polysorbate 60, Steareth-20, Steareth-21, Steareth-10, Poloxamer 407, Poloxamer 188, Poloxamer 124, Poloxamer 237, Poloxamer 338, Cetearyl Glucoside, Decyl Glucoside, Oleth-10, Ceteth-20, Ceteth-10, Oleth-20, PEG-8 Oleate, Isosteareth-20, C12-13 Pareth-3, C12-13 Pareth-4, C12-13 Pareth-23 and combinations thereof.

In some such embodiments, a composition includes a water in oil emulsifier. In some embodiments, a composition includes at least one water in oil emulsifier selected from the group consisting of a copolymer of Cetyl Dimethicone and an alkoxylated derivative of Dimethicone containing ethylene oxide and propylene oxide (e.g., Cetyl PEG/PPG-10/1 Dimethicone), Dimethicon Copolyol, steareth-2, Ceteth-2, sorbitan oleate, sorbitan stearate, sorbitan isosterate, sorbitan palmitate, sorbitan sesquioleate, Methyl Glucose Sesquioleate, sorbitan trioleate, glyceryl stearate, Polyglyceryl-3 Diisostearate, Polyglyceryl Fatty acid Esters, PEG-30 Dipolyhydroxystearate, Glyceryl Laurate, Polyglyceryl-4 Isostearate, PEG-7 Hydrogenated Castor Oil and combinations thereof

In some such embodiments a composition includes both an oil in water emulsifier and a water in oil emulsifier as a coemulsifier.

For example, in some embodiments a composition includes Ceteareth-20 as an oil in water emulsifier and, as a co-emulsifier, at least one water in oil emulsifier selected from the group consisting of Cetyl PEG/PPG Dimethicone, Dimethicon Copolyol and glyceryl stearate.

For example, in some embodiments a composition includes Ceteareth-20 and Ceteareth-12 as an oil in water emulsifier and, as a co-emulsifier, at least one water in oil emulsifier selected from the group consisting of Cetyl PEG/PPG-10/1 Dimethicone, Dimethicon Copolyol and glyceryl stearate.

Some embodiments include at least one non-aqueous solvent. In some such embodiments the non-aqueous solvent comprises a polyhydric alcohol (such as ethylene glycol, propylene glycol, glycerin, dipropylene glycol, butylene glycol, pentylene glycol, hexylene glycol or mixtures thereof), a polyol (such as glycerol), a monohydric alcohol, (such as methanol, ethanol, propanol, isopropanol, butanol, and combinations thereof). In some such embodiments, a non-aqueous solvent is isopropanol. In some such embodiments, the composition comprises from about 1 to about 10% non-aqueous solvent (w/w). In some embodiments, the composition comprises from about 2 to about 8%, and even from about 4 to about 6%, and even from about 5 to about 8% non-aqueous solvent (w/w). In some embodiments, the composition comprises from about 4 to about 4.5% isopropanol (w/w).

Some embodiments have an acidic pH, in some embodiments not more than about 4.0. In some embodiments, the pH is between about 2.4 and about 3.4. In some such embodiments, the low pH of the composition assists in dissolving nit glue.

In some embodiments, a pH adjuster is used to bring the pH of the composition to a desired pH value. In some such embodiments, the pH adjuster is selected from the group consisting of acetic acid, ascorbic acid, benzoic acid, citric acid, fumaric acid, hippuric acid, hydrochloric acid, hydroiodic acid, lactic acid, nitric acid, phosphoric acid, sulfuric acid and ethanolamine, or mixtures thereof. In some embodiments, the pH adjuster comprises acetic acid and/or triethanolamine.

In some embodiments, the composition comprises at least about 2%, at least about 3% and even at least about 4% by weight acetic acid. In some embodiments, the composition comprises from about 4 to about 5% by weight acetic acid. In some embodiments, the pH adjuster additionally or alternatively comprises triethanolamine.

Some embodiments include at least one solvent effective in dissolving nit glue. In some embodiments, such a solvent is selected from the group consisting of benzyl alcohol, diacetone alcohol, acetic acid, triethyl citrate and combinations thereof In some embodiments, the solvent comprises at least three components selected from the group consisting of benzyl alcohol, diacetone alcohol, acetic acid, and triethyl citrate. In some embodiments, the solvent comprises benzyl alcohol, diacetone alcohol, acetic acid, and triethyl citrate.

In some embodiments, the composition comprises at least about 2%, at least about 3% and even at least about 4% by weight diacetone alcohol. In some embodiments, the composition comprises from about 4 to about 4.5% by weight diacetone alcohol.

In some embodiments, the composition comprises at least about 1%, at least about 2% and even at least about 2.5% by weight triethyl citrate. In some embodiments, the composition comprises about 3% by weight triethyl citrate.

In some embodiments, the composition comprises at least about 0.2%, at least about 0.5% and even at least about 0.8% by weight benzyl alcohol. In some embodiments, the composition comprises about 1% by weight benzyl alcohol. In some embodiments, the benzyl alcohol also serves as a preservative.

In some embodiments, a composition includes at least one humectant. In some embodiments, the humectant is selected from the group consisting of glycerin; glycerol; propylene glycol; glyceryl triacetate; sugar polyols such as sorbitol, xylitol and maltitol; polymeric polyols such as polydextrose; quillaia, lactic acid or urea, or combinations thereof. In some embodiments, a humectant comprises glycerin. In some embodiments, the composition comprises at least about 1%, at least about 2% and even at least about 2.5% by weight of humectant. In some embodiments, the composition comprises about 2.5 to 3% by weight of glycerin.

In some embodiments, a composition includes at least one fragrance. Fragrances include, but are not limited to, perfumes, essential oils, extracts, absolutes, resinoids, concentrates, and mixtures thereof. Examples include terpenic hydrocarbons, esters, ethers, alcohols, aldehydes, ketones, acetals, and derivatives thereof and mixtures thereof. Other examples include fruit scents such as almond, apple, banana, blueberry, coconut, grape, grapefruit, lemon, lime, lychee, mandarin, melon, orange, pineapple, raspberry, strawberry, etc.; flower scents such as lavender, rose-like, carnation-like, rosemary, thyme, etc.; woodland scents such as pine, spruce, etc.; essential oils such as peppermint, spearmint, etc.

In some embodiments, a fragrance is selected from the group consisting of lychee, melon and orange peel fragrance.

According to some embodiments, there is provided a composition for dissolving nit glue comprising at least three components selected from the group consisting of benzyl alcohol, diacetone alcohol, acetic acid, and triethyl citrate.

Nit glue is a specialized saliva secreted by lice in order to attach nits (lice eggs) to the hair of a host, forming a very strong bond. Nits which remain in the hair may remain viable after elimination of adult lice, resulting in hatching of fresh nymphs, resulting in re-infestation even after all live lice have been removed.

In some embodiments, a solvent for dissolving nit glue is selected from the group consisting of benzyl alcohol, diacetone alcohol, acetic acid, triethyl citrate and combinations thereof In some embodiments, the solvent comprises at least three components selected from the group consisting of benzyl alcohol, diacetone alcohol, acetic acid, and triethyl citrate. In some embodiments, the solvent comprises benzyl alcohol, diacetone alcohol, acetic acid, and triethyl citrate.

In some embodiments, the composition comprises at least about 2%, at least about 3% and even at least about 4% by weight diacetone alcohol. In some embodiments, the composition comprises from about 4 to about 4.5% by weight diacetone alcohol.

In some embodiments, the composition comprises at least about 1%, at least about 2% and even at least about 2.5% by weight triethyl citrate. In some embodiments, the composition comprises about 3% by weight triethyl citrate.

In some embodiments, the composition comprises at least about 0.2%, at least about 0.5% and even at least about 0.8% by weight benzyl alcohol. In some embodiments, the composition comprises about 1% by weight benzyl alcohol. In some embodiments, the benzyl alcohol also serves as a preservative.

In some embodiments, the composition for dissolving nit glue further comprises a hair wetter i.e. an oil or solvent which spreads quickly over the hair.

In some embodiments, the hair wetter has a spreading coefficient of at least about 1200 mm/10 minutes. In some embodiments, the spreading coefficient is at least about 1250 mm /10 minutes, at least about 1400 mm/10 minutes, at least about 1450 mm/10 minutes, at least about 1560 mm/10 minutes, at least about 1600 mm/10 minutes, at least about 1700 mm/10 minutes, and even at least about 1840 mm/10 minutes.

Examples of suitable hair wetters include, without limitation, isopropyl myristate, dicaprylyl ether, dicaprylyl carbonate, isopropyl palmitate, C12-15 alkyl benzoate, isopropyl isostearate, butyl stearate, diisopropyl adipate, diisobutyl adipate, diethylhexyl adipate, butyl myristate, hexyl myristate, tributyl citrate, acetyltributyl citrate, acetyltriethyl citrate, ethylhexyl cocoate, ethylhexyl stearate, ethylhexyl pelargonate, ethylhexyl succinate, ethylhexyl cocoate, ethyl oleate, propylene glycol dicaprylate/caprate, propylheptyl caprylate, coco-caprylate, and PPG-2 myristyl ether propionate, or combinations thereof.

A list of exemplary hair wetters and their respective spreading coefficients is provided in Table 1.

TABLE 1
Hair Wetters

| | | Spreading |
|---|---|---|
| | | coefficient |
| Hair wetter/Emollient/Solvent | CAS Number | mm/10 minutes |
| Dicaprylyl Ether | 629-82-3 | 1600 |
| Dicaprylyl Carbonate | 1680-31-5 | 1600 |
| Isopropyl Myristate | 110-27-0 | 1200 |
| Diisopropyl Adipate | 6938-94-9 | 1840 |
| Isopropyl Palmitate | 142-91-6 | 1450 |
| Diisobutyl Adipate | 141-04-8 | 1990 |
| Ethylhexyl Cocoate | 92044-87-6 | 1470 |
| Diethylhexyl Adipate | 103-23-1 | 1430 |
| Ethyl Oleate | 111-62-6 | 1850 |
| Butyl Myristate | 64131-21-1 | 1700 |
| Isopropyl Isostearate | 68171-33-5 | 1250 |
| Butyl Stearate | 123-95-5 | 1660 |
| C12-15 Alkyl Benzoate | 68411-27-8 | 1360 |
| Propylheptyl Caprylate | 868839-23-0 | 1900 |
| Coco-Caprylate | 107525-85-9 | 1300 |
| PPG-2 Myristyl Ether Propionate | 74775-06-7 | 1600 |
| Ethylhexyl Pelargonate | 59587-44-9 | 1670 |
| Ethylhexyl Stearate | 22047-49-0 | 1400 |
| Ethylhexyl Succinate | 2915-57-3 | 1560 |
| Propylene Glycol Dicaprylate/ | 68583-51-7 | 1700 |
| Caprate | | |

According to a preferred embodiment, the hair wetter comprises isopropyl myristate, which, in addition to serving as a hair wetter, has pediculocidic properties.

The compositions described herein may be manufactured using processes well known in the art, e.g., by means of conventional mixing, dissolving, emulsifying etc. Further techniques for formulation and administration of active ingredients may be found in “Remington's Pharmaceutical Sciences,” Mack Publishing Co., Easton, Pa., latest edition, which is incorporated by reference as if fully set forth herein.

In some embodiments, a composition as described herein further comprises a suitable carrier to facilitate administration.

In some embodiments, a composition as described herein further comprises additional excipients and auxiliaries, known to those skilled in the art, to facilitate processing of the active ingredients into preparations which, can be used pharmaceutically. Non-limiting examples of such excipients include anti-oxidants, gelling agents, thickening agents, stabilizers, and the like.

A composition as described herein may be used for treating any subject suffering from pediculosis, either a human or a non-human animal. A composition as described herein may be used in any suitable manner, but is preferably applied topically to the subject, most preferably to the skin and/or hair and/or pelt and/or fur of the subject. In some embodiments, the composition is used in a manner analogous to the use of “Hairclean 1-2-3”® or Resultz®.

For topical administration, a composition as described herein is provided in any suitable form which enables the composition to remain in contact with the skin and/or hair for a desired time period. Non-limiting examples of suitable forms include a liquid, a gel, a cream, an ointment, a paste, a lotion, a milk, a suspension, an aerosol, a spray, a foam, or a serum.

In some embodiments, a composition as described herein is applied (e.g., by massaging into the hair) topically for a period of time up to about 15 minutes, up to about 10 minutes, and even up to about 5 minutes. In some embodiments, the composition is applied for about 5 minutes.

After the period of time, the hair is combed with a fine-tooth comb to remove lice.

In some embodiments, after the composition has been left in contact with the skin and/or hair of the subject, the composition is removed either by rinsing with water or by washing with normal shampoo followed by rinsing.

Exemplary embodiments are discussed hereinbelow with reference to specific materials, methods and examples. The material, methods and examples discussed herein are illustrative and not intended to be limiting. In some embodiments, methods and materials similar or equivalent to those described herein are used in the practice or testing of embodiments of the invention. It is to be understood that the invention is not necessarily limited in its application to the details of construction and the arrangement of the components and/or methods set forth in the following description and/or illustrated in the drawings. The invention is capable of other embodiments or of being practiced or carried out in various ways.

### Experimental

### Example 1

### Exemplary compositions

Three exemplary compositions that are embodiments of the teachings herein were prepared in accordance with the teachings herein using commercially-available ingredients are listed in Table 2:

TABLE 2
Components of compositions I, II and III

| | I | II | III | |
|---|---|---|---|---|
| Component | (% w/w) | (% w/w) | (% w/w) | |
| D.I. Water | 45.4 | 48.4 | 47.15 | solvent |
| Isopropanol | 4.5 | 4.0 | 4.7 | non aqueous |
| | | | | solvent |
| Isopropyl | 5.7 | 5.5 | 6.0 | Hair lubricant/ |
| myristate | | | | pediculicide |
| Cyclomethicone | 7.0 | 7.0 | 6.5 | Hair lubricant/ |
| (CM-040 and/or | | | | pediculicide |
| DC345) | | | | |
| Poly- | 1.5 | 1.0 | 1.0 | Hair Lubricant/ |
| quaternium-37 | | | | conditioner |
| (Ultragel ® 300) | | | | Thickener, |
| | | | | Stabilizer |
| Cyclo- | 0.5 | 0.5 | 0.6 | Hair lubricant/ |
| pentasiloxane | | | | conditioner/ |
| and/or | | | | pediculicide |
| Dimethiconol | | | | |
| (Belsil ® | | | | |
| CM1000 and./or | | | | |
| DC 1501 | | | | |
| and/or SF1202) | | | | |
| Cetyl PEG/ | 0.5 | 0.5 | 0.6 | water in oil |
| PPG-10/1 | | | | emulsifier, |
| Dimethicone | | | | hair |
| (Abil ® EM90) | | | | lubricant, |
| | | | | conditioner |
| Cetearyl | 14.0 | 14.0 | 14.0 | oil-in-water |
| Isononanoate, | | | | emulsion |
| Ceteareth-20, | | | | mixture |
| Cetearyl Alcohol, | | | | containing |
| Glyceryl Stearate, | | | | oil-in-water |
| Glycerin, | | | | emulsifiers, |
| Ceteareth-12, | | | | emollients, |
| Cetyl Palmitate | | | | wax, oil-in- |
| (Emulgade ® CM) | | | | water |
| | | | | coemulsifiers, |
| | | | | oily waxes |
| | | | | and humectants |
| Polyacrylate-1 | 2.0 | 2.0 | 0.1 | thickener, |
| Crosspolymer | | | | stabilizer |
| (Carbopol ® | | | | |
| Aqua CC) | | | | |
| PEG-150/Decyl | 0 | 0 | 2.7 | thickener, |
| Alcohol/SMDI | | | | stabilizer |
| Copolymer | | | | |
| (Aculyn ™ 44) | | | | |
| Diacetone Alcohol | 4.5 | 4.0 | 4.7 | Nit glue |
| | | | | dissolver |
| Glacial acetic | 4.8 | 4.0 | 5.0 | Nit glue |
| acid | | | | dissolver, |
| | | | | pH adjustor |
| Triethyl Citrate | 3.0 | 3.0 | 3.0 | Nit glue |
| | | | | dissolver |
| Benzyl alcohol | 1.0 | 1.0 | 1.0 | Nit glue |
| | | | | dissolver/ |
| | | | | preservative |
| Glycerin | 3 | 2.5 | 1.0 | humectant |
| Lychee-Melon | 1.5 | 1.5 | 1.8 | fragrance |
| Fragrance | | | | |
| Orange Peel | 1.0 | 1.0 | 0.1 | fragrance |
| Fragrance | | | | |
| Triethanolamine | qs (0.1) | qs (0.1) | qs (0.05) | pH adjustor |

### Materials:

The required materials were purchased from commercial suppliers: isopropanol (CAS 67-63-0), diacetone alcohol (CAS 123-42-2) and glycerin (CAS 56-81-5) from Gadot Lab Supplies (Or Akiva, Israel);

isopropyl myristate (CAS 110-27-0) and Polyquaternium-37 (Ultragel® 300, CAS 26161-33-1) from Cognis (Monheim, Germany a subsidiary of BASF SE, Ludwigshafen, Germany);

cyclomethicone was CM-040 from Wacker Chemie AG (Munich, Germany) and/or DC345 from Dow Corning Corporation (Midland, Mich., USA);

cyclopentasiloxane and/or dimethiconol for Compositions I and II was DC 1501 from Dow Corning Corporation and/or Belsil® CM 1000 from Wacker Chemie AG (Munchen, Germany), and for Composition III was SF1202 from Momentive Performance Materials Inc. (Albany, N.Y., USA);

a blend of Cetearyl Isononanoate, Ceteareth-20, Cetearyl Alcohol, Glyceryl Stearate, Glycerin, Ceteareth-12 and Cetyl Palmitate (CAS Numbers: 84878-33-1, 84878-34-2, 68439-49-6, 67762-27-0, 67701-33-1, 56-81-5, 95912-87-1, 68439-49-6) was Emulgade® CM from Cognis part of BASF SE (Ludwigshafen, Germany);

cetyl PEG/PPG-10/1 dimethicone was Abil® EM90 (CAS 145686-34-6) from Evonik Goldschmidt GmbH (Essen, Germany);

polyacrylate-1 crosspolymer was Carbopol® Aqua CC from Lubrizol Corporation (Wickliffe, Ohio, USA);

glacial acetic acid (CAS 64-19-7) from Riedel-de Haën (Seelze, Germany);

triethyl citrate (CAS 77-93-0) and benzyl alcohol (CAS 100-51-6) from Sharon Laboratories (Ashdod, Israel);

lychee-melon fragrance and orange peel fragrance from S. M. Naturals (North Richland, Texas, USA);

triethanolamine (CAS 102-71-6) from Merck KgGA (Darmstadt, Germany); and PEG-150/Decyl Alcohol/SMDI Copolymer was Aculyn™ 44 from Rohm and Haas (Philadelphia, Pa., USA) a subsidiary of Dow Chemical (Midland, Mich., USA).

### Example 2

### Preparation of an Exemplary Composition

A clean mixer equipped with agitating planetary propeller and high shear homogenizer or dispersing disc was prepared. Diacetone alcohol, isopropyl alcohol, acetic acid, glycerin, benzyl alcohol, triethyl citrate and fragrances were added to the mixer at room temperature, with stirring for 5 minutes.

In an auxiliary vessel, a mixture of Polyquaternium-37 in water was prepared by mixing at room temperature until a clear gel was obtained. The mixture was checked to ensure complete dissolution of the Polyquaternium-37. The clear gel from the auxiliary vessel was added to the mixer while mixing. The contents of the mixer were mixed for an additional 5 minutes.

Cetearyl isononanoate (and) Ceteareth-20 (and) cetearyl alcohol (and) glyceryl stearate (and) glycerin (and) Ceteareth-12 (and) cetyl palmitate, isopropyl myristate, and cyclopentasiloxane, were added to the mixer, at room temperature, while mixing, and stirred for 5 minutes. Mixing was continued until a smooth, white, emulsion was obtained.

Cyclopentasiloxane (and) dimethiconol, and cetyl PEG/PPG-10/1 dimethicone were added while applying high shear homogenizer or high rpm dispersing disc. Mixing was continued until a smooth, white, gel-emulsion was obtained

Polyacrylate-1 Crosspolymer (and in Compositions II and III, also PEG-150/Decyl Alcohol/SMDI Copolymer) was added to the mixer, at room temperature, while mixing. Mixing was continued until a smooth, white, gel-cream was obtained. The pH of the mixture was adjusted from 2.4 to 3.2 by adding triethanolamine.

The resulting composition was a homogenous white-colored emulsion.

### Example 3

### Pediculicidal Activity of the Exemplary Compositions

The pediculicidal and ovicidal activities of exemplary compositions are tested in the laboratory on lice according to the following procedure:

Body lice (Pediculus humanus humanus) are reared in the laboratory according to the method described by Cole M. M. [Body lice. In: Insect colonization and mass production. Smith, C. N. (ed.), Academic Press, N. York, p. 15-24 (1966)].

For each test, 50 lice (10 males, 10 females and 30 nymphs) are placed on a 7-cm white filter paper disc and exposed to 1 gram of an exemplary composition. The lice are left in contact with the composition for 5 to 15 minutes. The lice are then removed from the filter paper, washed with normal shampoo (1:20) for 1 minute and then with tap water for 1 minute. After treatment, lice are transferred to a fresh filter paper disc and incubated overnight at optimum temperature and humidity. Mortality is determined after 24 hours. As a negative control, lice are treated with an isopropanol or 40% ethanol/60% water solution. Each exposure time is tested in triplicate.

### Example 4

### Ovicidal Activity of the Exemplary Compositions

Lice are placed on human hair every other day for 5 days and left for 24 to 48 hrs for oviposition. Fifty nits (lice eggs) 2 to 6 days old, are treated with the exemplary compositions, as described above. The number of hatched and non-hatched nits are counted after 10 days. Each exposure time is tested in triplicate.

### Example 5

### Pediculicidal Activity of Composition III

The pediculicidal and ovicidal activities of composition III were tested in the laboratory on lice according to the following procedure.

Body lice (Pediculus humanus humanus) were reared in the laboratory according to the method described by Cole M. M. [Body lice. In: Insect colonization and mass production. Smith, C. N. (ed.), Academic Press, New York, N.Y., USA p. 15-24 (1966)].

For each test, 50 lice (10 males, 10 females and 30 nymphs) were placed on a 7-cm white filter paper disc and exposed to 1 gram of composition III. The lice were left in contact with the composition for 5 to 15 minutes. The lice were then removed from the filter paper, washed with normal shampoo (1:20) for 1 minute and then with tap water for 1 minute. After treatment, the lice were transferred to a fresh filter paper disc and incubated overnight at optimum temperature and humidity. Mortality was determined after 24 hours. As a negative control, lice were treated with a solution of 40% ethanol/60% water. Each exposure time was tested in triplicate. The results are listed in Table 3.

### Example 6

### Ovicidal Activity of Composition III

Lice were placed on human hair every other day for 5 days and left for 24 to 48 hours for oviposition. Fifty nits, 2 to 6 days old, were treated with composition III, as described above in Example 3. The number of hatched and non-hatched nits were counted after 10 days. Each exposure time was tested in triplicate. The results are listed in Table 3.

TABLE 3
Pediculicidal and Ovicidal activity of composition III

| | | Example 5 | Example 6 |
|---|---|---|---|
| | Exposure | Mean lice | Mean nit |
| Composition | time [min] | mortality [%] | mortality [%] |
| III | 5 | 100 | 100 |
| III | 10 | 100 | 100 |
| III | 15 | 100 | 100 |
| Control | 15 | 12 | 16 |

From Table 3 is seen that composition III, an embodiment of the composition described herein, shows significant pediculicidal and ovicidal activity, after exposure times even at least as short as 5 minutes.

### Example 7

### Clinical Study of Composition III

To study the clinical efficacy, as well as ease of use and tolerability, of composition III, 30 human children aged 5 to 15 years (average age: 8.8 years, 82% females, 75% having long hair) were treated with a single application of composition III.

### Before Application of Composition III

The hair of the children was examined by a qualified nurse. It was ascertained that the hair of 89% of the children was infested with lice (mean: 30 lice) and nits (mean: 150 nits). 15% of the children had greater than 200 lice.

### Application of Composition III

A child's hair was dampened. Composition III was applied to the damp hair of the child, and massaged-in to ensure that the composition contacted substantially all the hair and scalp. A qualified nurse combed a section of the hair with a louse-comb in the usual way at 5, 10, 15 and 20 minutes after application of the composition. After the combing subsequent to 20 minutes from application of the composition, the child's hair was rinsed with water and the qualified nurse thoroughly combed the hair with a louse-comb in the usual way. After another 7 days, a qualified nurse thoroughly combed the child's hair with a louse-comb in the usual way.

Five Minutes after Application of Composition III

Five minutes after application of composition III, a first section of the child's hair was combed with a louse-comb. In 80% of the children, only dead lice and no living lice were recovered from the louse-comb. In 70% of the children, the nits were easily removed with the louse-comb from the first section of the hair, indicating that the composition had dissolved the nit glue.

Ten Minutes after Application of Composition III

Ten minutes after application of composition III, a second section of the hair (different from the first section) of the child's hair was combed with a louse-comb. In all of the children, only dead lice and no living lice were recovered from the louse-comb. In 90% of the children, the nits were easily removed with the louse-comb from the second section of the hair, indicating that the composition had dissolved the nit glue.

Fifteen and Twenty Minutes after Application of Composition III

Fifteen and twenty minutes after application of composition III, no living lice were recovered using the louse comb from the hair of any of the children and nits were easily removed from the hair of all of the children.

### After Rinsing and Brushing

After the composition was rinsed from a child's hair, the hair was brushed and combed using a louse-comb in the usual way. No substantial residue of the composition was observed in the hair of any of the children. Subsequently, the hair was thoroughly combed with a louse-comb. No dead lice were recovered from the louse-comb of 80% of the children, and an average of 2 dead lice were recovered from the louse comb of 20% of the children. An average of 30 nits were recovered from the louse-comb.

### After Seven Days

Seven days after the treatment, a few nits were found in the hair of some of the children. In the hair of two of the children who previously had more than 200 living lice, a few living nymphs were found.

### Conclusions

Composition III was well-tolerated (including acceptable scent), easy to apply and no adverse reactions were observed. After rinsing of the hair, no substantial residue of compositions was noted in the hair.

The composition was found to be highly effective in treating lice infestation even at short application times. The presence of several living nymphs in some children indicate that it may be advisable to repeat treatment after about 7 days in cases of exceptionally serious infestation.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

1-3. (canceled)

4. A method for the treatment of pediculosis, comprising topically administering to a subject in need thereof a composition comprising between 1 and 20% (w/w) isopropyl myristate, between 1 and 20% (w/w) silicone oil, and at least 20% (w/w) water.

5-6. (canceled)

7. The method of claim 4, wherein said silicone oil is selected from the group consisting of a polyalkyl siloxane, a polyaryl siloxane, a polyalkylaryl siloxane, a polyether siloxane copolymer, and combinations thereof.

8. The composite method of claim 7, wherein said polyalkyl siloxane comprises cyclomethicone.

9. The composition method of claim 8, wherein said polyalkyl siloxane further comprises dimethicone.

10. The composition method of claim 4, further comprising at least one selected from the group consisting of a hair conditioner and a lubricant.

11. (canceled)

12. The method of claim 4, further comprising at least one selected from the group consisting of a thickener and a stabilizer.

13-14. (canceled)

15. The method of claim 4, further comprising at least one emulsifier is-selected from the group consisting of a water in oil emulsifier and an oil in water emulsifier, or combinations thereof.

16-18. (canceled)

19. The method of claim 4, further comprising at least one non-aqueous solvent.

20. The method of claim 19, wherein said at least one non-aqueous solvent comprises isopropanol.

21. The method of claim 4, said composition having a pH of less than about 4.

22. The method of claim 21, further comprising a pH adjuster.

23. The method of claim 22, wherein said pH adjuster is selected from the group consisting of acetic acid and triethanolamine, and mixtures thereof.

24. The method of claim 4, further comprising at least one solvent effective in dissolving nit glue.

25. The method of claim 24, wherein said at least one solvent effective in dissolving nit glue comprises at least three selected from the group consisting of benzyl alcohol, diacetone alcohol, acetic acid, and triethyl citrate.

26. The method of claim 4, further comprising combing the hair of said subject.

27. The method of claim 26, wherein a period of time in the range of from about 5 to about 15 minutes is allowed to elapse between said application of said composition and said combing of said hair.

28-31. (canceled)

32. A method for the treatment of pediculosis, comprising topically administering to a subject in need thereof a composition comprising at least three components selected from the group consisting of benzyl alcohol, diacetone alcohol, acetic acid, and triethyl citrate.

33. (canceled)

34. The method of claim 32, said composition further comprising a hair wetter.

35. (canceled)

36. The method of claim 34, wherein said hair wetter is selected from the group consisting of isopropyl myristate, dicaprylyl ether, dicaprylyl carbonate, isopropyl palmitate, C₁₂₋₁₅ alkyl benzoate, isopropyl isostearate, butyl stearate, diisopropyl adipate, diisobutyl adipate, diethylhexyl adipate, butyl myristate, hexyl myristate, tributyl citrate, acetyltributyl citrate, acetyltriethyl citrate, ethylhexyl cocoate, ethylhexyl stearate, ethylhexyl pelargonate, ethylhexyl succinate, ethylhexyl cocoate, ethyl oleate, propylene glycol dicaprylate/caprate, propylheptyl caprylate, coco-caprylate, and PPG-2 myristyl ether propionate, or combinations thereof.

37. The method of claim 36, wherein said hair wetter comprises isopropyl myristate.
